(19) United States
(12) Patent Application Publication
(10) Pub. No.: US 2006/0139374 A1
(43) Pub. Date: Jun. 29, 2006

(54) Method and virtual retinal display for reproducing the image of a person

(75) Inventors: Rudolf Ritter, Zollikofen (CH); Eric Lauper, Bern (CH)

Correspondence Address: PEARNE & GORDON LLP, 1801 EAST 9TH STREET, SUITE 1200, CLEVELAND, OH, 44114-3108, US

(73) Assignee: Swisscom Mobile AG, Bern (CH)

(21) Appl. No.: 11/292,422

(22) Filed: Dec. 2, 2005

(30) Foreign Application Priority Data
Dec. 2, 2004 (EP) 2004EP-106256

(51) Int. Cl. G09G 5/00; G06F 3/00; G07F 7/00

(52) U.S. Cl. 345/633; 715/762; 715/962; 705/27

(57) ABSTRACT

A method for reproducing the image of a person is disclosed. According to the invention, an image of a person or of part of a person is recorded with an image recording sensor (1.5) and the recorded image is immediately afterwards projected in modified or unchanged form with a Virtual Retinal Display (1.1) directly onto the retina (2.1) of the person. The invention also relates to a Virtual Retinal Display (1.1) for reproducing the image of a person, wherein an image recording sensor (1.5) and the Virtual Retinal Display (1.1) are connected with an electronic analysis unit (1.2) for analyzing and modifying a recorded image.

### REFERENCE DATA

The present invention claims priority of European Patent Application 2004EP-106256 filed on Dec. 2, 2004 in the European Patent Office, the disclosure of which is hereby incorporated by reference.

### TECHNICAL BACKGROUND

The invention relates to a method for reproducing the image of a person with a Virtual Retinal Display according to the independent method claim and to a Virtual Retinal Display for reproducing the image of a person according to the independent device claim.

### RELATED ART

Different methods and systems are known in the prior art for recognizing a person and distributing personal information to that person. WO-A1-2004/047060 for example discloses a mirror that is equipped with a face-recognition system and with a display integrated in the mirror. A person is recognized in the recognition system on the basis of images recorded with a camera. Data attributed to the recognized person are retrieved from a memory and reproduced to the person on a display integrated in the mirror. This system however has the disadvantage that the person must be recognized personally and that it is not possible to play to a certain group of persons any program tailored for this group of persons. It is also disadvantageously not known from WO-A1-2004/047060 to use the mirror itself as display; on the contrary, it is necessary to integrate a display at a certain place in the mirror. Furthermore, no special displays are known from the patent application that project the data directly onto the retina of the observer's eye. A similar system is known from application WO-A1-03/005177.

Patent U.S. Pat. No. 6,560,027 discloses a mirror that can simultaneously serve as display. In this mode, it is possible to display e-mails and information or a person's diary. A disadvantage in this system is that no recognition of the person in front of the mirror is possible.

Patent application DE-A1-196 35 753 discloses an image generation device that generates a virtual image of a dressed person resembling a user and wearing certain selected items of clothing. Furthermore, a method for generating the virtual puppets and items of clothing necessary for the representation are also known from this patent application.

Japanese publication JP-A-2 285 172 discloses a television integrated in a bathroom mirror. From WO00/14941, a reflecting display for a handy is known that can be turned into a reflecting surface through an electric signal.

### REPRESENTATION OF THE INVENTION

It is an aim of the present invention to create a method and a device with which a person can see himself or herself in modified or unchanged form, such as for example in another environment or in other clothes. It should additionally be possible to play to this person an advertising, information or entertainment program specially tailored to a group of persons or a person-linked data file.

The aim is achieved with a method for reproducing the image of a person with a Virtual Retinal Display having the following method steps:
the image of a person or part of a person is recorded with an image recording sensor, and
immediately afterwards, the recorded image of the person is reproduced in modified or unchanged form with a Virtual Retinal Display directly onto the person's retina.

The aim is also achieved through a Virtual Retinal Display for reproducing the image of a person, wherein an image recording sensor is connected with an electronic analysis unit for analyzing the recorded image of the person and the virtual Retinal Display is connected with the analysis unit for reproducing the image.

With the inventive method, the person can advantageously see himself or herself in modified or unchanged fashion. This can be when shopping in a store, wherein the person sees himself or herself with a new pair of glasses, with other clothes or in a selected living room or office. If the system is designed interactively, the person can easily change the environment or clothing and thus has better criteria for decision, for example when buying furniture or items of clothing. Since the person does not necessarily have to put on the items of clothing, a plurality of changes can without effort be generated virtually. Since the device is very small and also portable, it can be set up and used everywhere without problem and with minimal space requirements. In stores, large mirrors that can reflect the whole person can thus advantageously be omitted. The inventive method can for example also be used in connection with game consoles, wherein the person can find himself or herself in a virtual world and interact with other persons. Use of the method for a video conference with business partners is also possible. The system can be designed interactively and the person can control it over a voice or sensor input, over a virtual keyboard or through eye movements.

On the basis of the recognition of the person observing himself or herself in the virtual mirror, an advertising, information or entertainment program can additionally be played. If the person cannot be determined personally but only a category such as young, middle-aged, old, male, female, long hair, short hair, child etc. is detected, an advertising, information or entertainment program tailored for this category is made available. By recording the biometric characteristics of the face, such as the person's iris or retina, it is however also possible to identify the person personally, or to authenticate a conjectured identity, and to play additionally to the own image person-linked messages such as e-mails etc. or a preferred entertainment program. In another embodiment, the system knows from experience which information a person prefers and will reproduce the latter accordingly. In similar manner, the biometric recognition and authentication of the person vis-à-vis a service or an object is possible.

The inventive system has versatile uses both for public as well as for private areas. It has the advantage that in the general case, advertising and information can be distributed in targeted fashion to a category of persons. In the private range, the system can be trained specifically to persons to that a program tailored individually to the person can be played. People who spend time in front of the mirror for their own personal care generally also have time, at least during said activity, to watch said television program, internet data, advertisements, information or an entertainment program.

The inventive method and the inventive system are advantageously used in many ways in connection with an existing broadcast, fixed or mobile network, over which not only advertising, information or entertainment programs but also internet data files, images etc. can be downloaded. It is also conceivable to send the recorded image of the person to a remote server and to process and modified it in an analysis unit that is part of the remote server. The modified image is then sent through the communication network to the Virtual Retinal Display and is visible for the user.

In an advantageous embodiment, the Virtual Retinal Display, image recording sensor and analysis unit are integrated in a mobile device, for example in a mobile telephone, or even in a single chip having an autonomous power supply. The user of the mobile device can thus without problem participate with the device itself to a video conference, a video game etc. and sees himself or herself besides the conversation partners or game players.

### SHORT DESCRIPTION OF THE FIGURES

The invention will be described in more detail with the aid of the attached figures in which:

FIG. 1 represents a first embodiment of an inventive system showing a mirror with an integrated scanner and an integrated Virtual Retinal Display, wherein the system is connected with a broadcast network;

FIG. 2 represents a second embodiment of an inventive system, wherein the system is connected with a mobile radio network.

Only the elements needed for understanding the invention are represented. The same elements in different figures have the same references.

### WAYS FOR EXECUTING THE INVENTION

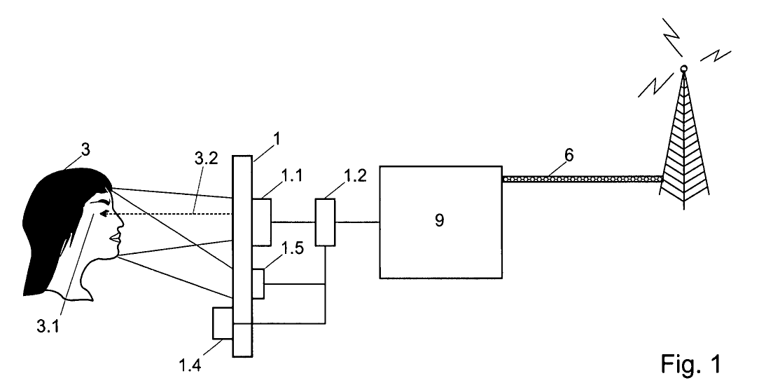

FIG. 1 shows a first embodiment with which the inventive method can be performed. Therein, a person is in front of a virtual mirror 1. An image recording sensor 1.5 and a Virtual Retinal Display 1.1 are integrated in this virtual mirror 1. The function of the image recording sensor can be performed by the Virtual Retinal Display 1.1. itself, but it can also be part of the virtual mirror 1. If the Virtual Retinal Display 1.1 itself serves as image recording sensor 1.5, it is provided with a light sensor additionally to the light-emitting diode. The image recording sensor 1.5 can be a matrix sensor, for example a ccD sensor or a scanning sensor. It is conceivable that a laser illuminates the person or the image of the person with infrared light (or with light of another wavelength) and a camera or sensor records the image of the person.

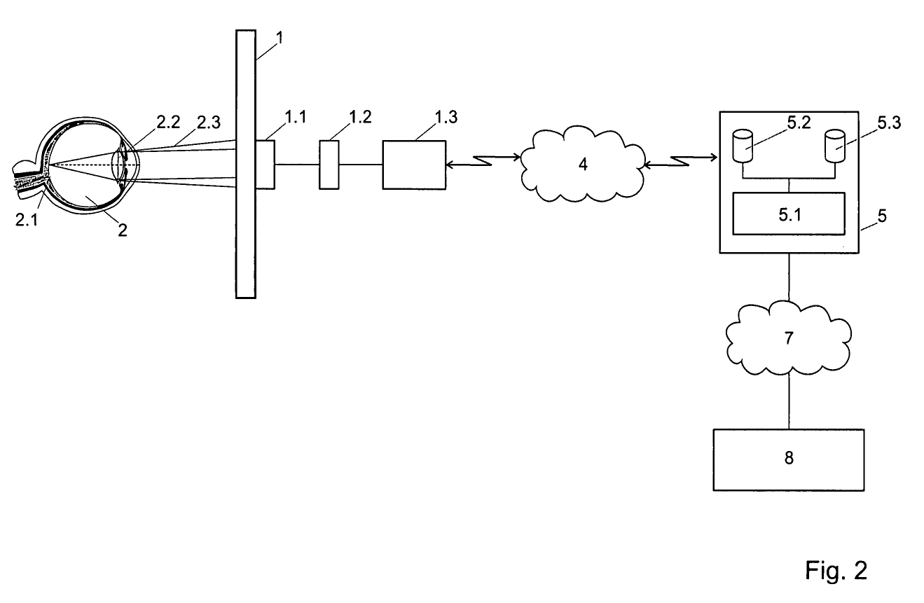

According to the present invention, a person is first recorded in front of a virtual mirror 1 with the image recording sensor 1.5. In the embodiment of FIG. 1, only the person's face is represented and only the face 3.1 is recorded. The image recording sensor 1.5 can also make a picture of the entire person or only record the iris 2.2 or the retina 2.1 (see FIG. 2). The recorded image of the person is immediately afterwards reproduced resp. projected in modified or unchanged form with a Virtual Retinal Display 1.1 directly on the retina 2.1 of the person. This is represented in FIG. 1 through the projection 3.2. “Immediately afterwards” refers to the time that is required for image processing and modifying through the analysis unit 1.2. Such VRD devices are among others commercialized by the company Microvision and have the advantage that they can be strongly miniaturized and have low power consumption. For changing or processing the image, an analysis unit 1.2 is connected to the Virtual Retinal Display 1.1 and to the image recording sensor 1.5. The analysis unit 1.2 is for example a normal PC, a Linux or Symbian system, in which a corresponding image processing software performs the image analysis and modification. In order for the analysis unit 1.2 to provide or compute the image of the person correctly, it is necessary that the Virtual Retinal Display 1.1 and the image recording sensor 1.5 remain in a fixed angle to one another.

The virtual mirror 1 can be a real mirror with a surface that is (at least partly) reflecting. This is not absolutely necessary for a Virtual Retinal Display 1.1. A small portable device or a chip on which an image recording sensor 1.5, an analysis unit 1.2 and a Virtual Retinal Display 1.1 can be integrated are also conceivable. Such an embodiment has minimal space requirements since the display itself is considerably smaller than the projected image, which can represent an entire room. It is also possible to record considerably larger images. It is also cheaper than mirrors known to date, described in the prior art, in which a display has been integrated. In order to be able to operate autonomously, it has a power supply. It must thus be switched on separately in order to function as a mirror.

In order for the reproduction of the image to be projected accurately onto the retina 2.1, it is necessary to monitor and follow the eye's position or movements and to take into account the determined position for reproducing the image through the Virtual Retinal Display 1.1. Only thus is it possible to reproduce the image accurately.

With the inventive method, the person can advantageously see himself or herself in modified or unchanged fashion. This can be when shopping in a store, wherein the person sees himself or herself with a new pair of glasses, with other clothes or in a selected living room or office. Since the person does not necessarily have to put on the items of clothing, but the image is generated in an analysis unit 1.2, a plurality of changes can be generated virtually in a short time. Since the device can be very small, it can be set up and used everywhere without problem. In stores, large mirrors that can reflect the whole person can thus advantageously be omitted. The inventive method can for example also be used in connection with game consoles, wherein the person can find himself or herself in a virtual world and interact with other persons.

As can be seen in FIG. 1, a module 1.4 for voice or sensor input or a virtual keyboard (that records the movements of the fingers) can be connected to the analysis unit 1.2. An interaction between the movements of the eyes (blinking, staring in a particular corner for a certain time, squinting, etc.) or through movements that are performed by body parts (hands, arms, etc.), is also conceivable. The system is thus interactive and the person can modify through easy commands the environment or the clothing and thus has better criteria for decision for example when buying furniture or items of clothing. A video conference with business partners is also interactive thanks to the inventive method. In a further embodiment, the Virtual Retinal Display 1.1 is integrated in a pair of glasses, whilst the image recording sensor 1.5 is not part of these glasses but is located outside the personal glasses.

In a further embodiment, though a person is not determined or recognized personally through the recorded image, a category (young, middle-aged, old, male, female, long hair, short hair, child etc.) to be attributed to the person is however detected in the analysis unit 1.2. An advertising, information or entertainment program tailored for this detected category is then made available and projected in addition to the own image through the Virtual Retinal Display 1.1. For this purpose, the analysis unit 1.2 in FIG. 1 is additionally connected over a broadcast receiver 9 to a broadcast network 6. It is possible easily to receive data over the broadcast network 6. Such a method has versatile uses both for public as well as for private areas. It has the advantage that in the general case, advertising and information can be distributed in targeted fashion to a category of persons.

The image represented can be adjusted to the content. It is thus not necessary to project a rectangular image. In fact, the image can stop with the outline of the person. For this purpose, a recognition process of the body parts must be carried out in the analysis unit 1.2. In this manner, it is possible to represent only the eyes or other body parts and to have the normal environment as background. The projected form of the image is modified automatically or manually. If several cameras are available that record a person from different angles, the representation of a three-dimensional image is also possible. To represent a three-dimensional image, two Virtual Retinal Displays 1.1, or only one Virtual Retinal Display 1.1 reproducing one image per eye, are necessary.

FIG. 2 shows a second embodiment with which the inventive method can be performed. A virtual mirror 1 is connected again with a Virtual Retinal Display 1.1. In FIG. 2, in which only the eye 2 of the person is represented, it is possible to identify personally the person by scanning the person's face, retina 2.1 or iris 2.2. The recording in this case is carried out by the Virtual Retinal Display 1.1 itself. If the person has been authenticated in the analysis unit 1.2 connected with the Virtual Retinal Display 1.1, further functions can be activated. It is thus possible to send to the user additionally to the own image individual and person-dependent messages (emails, messages corresponding to a user profile, etc.) or to play an entertainment program etc. preferred by the person. In the private range, the system can be trained in such a manner that a program tailored individually to the person can be played. People who spend time in front of the mirror for their own personal care generally also have time, at least during said activity, to watch said advertising or information program. In a preferred embodiment, the system knows from experience which information a person prefers and will then reproduce the latter accordingly.

It is further conceivable to use the inventive method as advertising billboard. The users' attention will thus first be caught by their own image. Then additional advertising sequences are played to inform the users about products, services, etc. In the end, the users will be surprised by the manner in which the information was presented and will be more prone to buying the products.

It is also conceivable that the person is identified biometrically through recognition of the face 3.1, retina 2.1, iris 2.2 or in any other manner, in order to be authenticated vis-à-vis a service (calling, secured data files, etc.) or an object (safety lock, access to restricted areas in buildings, etc.).

In FIG. 2, the analysis unit is connected over a communication unit 1.3 with a mobile radio network 4. The embodiment is in now way limited to a mobile radio network 4, it could also be any other suitable communication network, a fixed network, the Internet etc. The mobile radio network 4 is connected with a server 5. A database 5.1, customer data 5.2, a provider administration 5.3 etc. are available on the server 5. In this manner, a provider 8 of an advertising or information program that is also connected over a communication network 7 with the server 5 can make the requested data available. The provider 8 will be provider of a said advertising, information or entertainment program for certain target or interest groups or can administer person-linked customer data 5.2 such as e-mails etc.

In this embodiment, it is also conceivable to send the recorded image of the person to the server 5 and to process and modify it in an analysis unit that is part of the server 5. The modified image can then be sent through the communication network to the Virtual Retinal Display 1.1 and is visible to the user.

In an advantageous embodiment, said elements, Virtual Retinal Display 1.1, image recording sensor 1.5 and analysis unit 1.2 are integrated in a mobile device, for example in a mobile telephone, and/or connected with a mobile telephone. All elements can however also be integrated in a single module that has its own power supply. The user of the mobile device can thus without problem participate with the device itself to a video conference, a video game etc. and sees himself or herself besides the conversation partners or game players.

### LIST OF REFERENCE SIGNS

1 Virtual mirror
1.1 Virtual Retinal Display
1.2 Analysis unit
1.3 Communication unit
1.4 Module for voice and/or sensor input
1.5 Image recording sensor
2 Human eye
2.1 Retina
2.2 Iris
2.3 Projection of the image
3 Head
3.1 Face
3.2 Projection of the image
4 Mobile radio network
5 Server
5.1 Database
5.2 Customer data
5.3 Provider administration
6 Broadcast network
7 Communication network
8 Provider of an advertising or information program
9 Broadcast receiver

1. Method for reproducing the image of a person with a Virtual Retinal Display, with the following method steps:
the image of a person or part of a person is recorded with an image recording sensor, and
immediately afterwards, the recorded image of the person is reproduced in modified or unchanged form with a Virtual Retinal Display directly onto the person's retina.

2. The method of claim 1, wherein only the face of the person is recorded.

3. The method of claim 1, wherein the person is represented in another environment or in other clothing.

4. The method of claim 1, wherein the image is recorded by a matrix sensor or by the Virtual Retinal Display itself as image recording sensor.

5. The method of claim 1, wherein the Virtual Retinal Display is connected locally or over a broadcast, fixed or mobile network with a data processing unit and wherein a data file available on the data processing unit is played to the person in addition to the recorded image.

6. The method of claim 1, wherein a television program, internet data, advertising, information or an entertainment program is played to the person in addition to the image.

7. The method of claim 6, wherein the person is categorized in an analysis unit and the television program, internet data, advertising, information or entertainment program is chosen according to the category.

8. The method of claim 1, wherein the person is recognized through recognition of the face, the retina or the iris in order to be authenticated vis-à-vis a service or an object.

9. The method of claim 1, wherein the person is recognized through recognition of the face, the retina or the iris and a person-dependent data file is played to the person in addition to the recorded image.

10. The method of claim 9, wherein as person-linked data file, the image of a conversation partner during a video conference is played.

11. The method of claim 1, wherein the method is used in a game console.

12. The method of claim 1, wherein the representation of the image and/or of other represented data is controlled by the person over a voice or sensor command, over a virtual keyboard or through eye movements.

13. Virtual Retinal Display for reproducing the image of a person, wherein an image recording sensor is connected with an electronic analysis unit for analyzing a recorded image of the person and the Virtual Retinal Display is connected with the analysis unit for reproducing the image.

14. The Virtual Retinal Display of claim 13, wherein the image recording sensor is a matrix sensor or the Virtual Retinal Display itself.

15. The Virtual Retinal Display of claim 13, wherein the image recording sensor and the Virtual Retinal Display are in a single module.

16. The Virtual Retinal Display of claim 13, wherein the Virtual Retinal Display and the image recording sensor are integrated in a mobile device, preferably a mobile telephone, and/or connected with the mobile device.

17. The Virtual Retinal Display of claim 13, wherein a module for voice and/or sensor command or a virtual keyboard is connected with the analysis unit.

18. The Virtual Retinal Display of claim 13, wherein the Virtual Retinal Display is connected locally or over a broadcast, fixed or mobile network with a data processing unit containing data files to be played.

19. The Virtual Retinal Display of claim 18, wherein the data file to be played contains the image of a conversation partner during a video conference.

20. The Virtual Retinal Display of claim 18, wherein the data processing unit contains a television program, internet data, advertising, information or an entertainment program as data file to be played.
